(19) United States
(12) Patent Application Publication
(10) Pub. No.: US 2024/0390881 A1
(43) Pub. Date: Nov. 28, 2024

(54) METHOD FOR SYNTHESIS OF COPPER-NICKEL POLYHEDRAL NANOCRYSTALS

(71) Applicant: HONDA MOTOR CO., LTD., Tokyo (JP)

(72) Inventors: Gugang CHEN, Powell, OH (US); Shutang CHEN, Powell, OH (US)

(21) Appl. No.: 18/322,975

(22) Filed: May 24, 2023

(51) Int. Cl. B01J 27/185; B01J 35/02; B01J 37/08; H01M 8/1004; H01M 8/1018

(52) U.S. Cl. CPC B01J 27/1853; B01J 35/50; B01J 37/08; H01M 8/1004; H01M 8/1018; H01M 2008/1095

(57) ABSTRACT

A method of making a hollow nanocatalyst having at least one non-metal component which includes providing a metal nanostructure, combining the metal nanostructure with a non-metal source to provide a combination, and heating the combination to a first elevated temperature to provide the hollow nanocatalyst. Also disclosed are hollow nanocatalysts having a first metal component, a second metal component, and a non-metal component.

### TECHNICAL FIELD

The present disclosure is directed to nanocatalysts useful in the hydrogen evolution reaction.

### BACKGROUND

Platinum and platinum-group metals have long been used as electrocatalysts for the hydrogen evolution reaction. However, such electrocatalysts are expensive and thus prohibit extensive commercialization. There is therefore a need in an the art for cheap, robust alternatives. One particularly attractive option would be an electrocatalyst having earth-abundant elements. However, there are currently no such catalyst that shows sufficient catalytic and utilization efficiency.

### SUMMARY

The present disclosure is directed to a method of making a hollow nanocatalyst having at least one non-metal component, the method including providing a metal nanostructure, combining the metal nanostructure with a non-metal source to provide a combination, and heating the combination to a first elevated temperature to provide the hollow nanocatalyst. The disclosure is also directed to a hollow nanocatalyst having a first metal component, a second metal component, and a non-metal component.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows one example schematic of a method according to the present disclosure.

FIG. 2A shows an SEM image of the copper-nickel polyhedral nanoparticles prepared according to Example III.

FIG. 2B shows an SEM image of the copper-nickel phosphide nanocrystals prepared according to Examples IV(a).

FIG. 2C shows an SEM image of the copper-nickel phosphide nanocrystals prepared according to Examples IV(b).

FIG. 2D shows an SEM image of the copper-nickel phosphide nanocrystals prepared according to Examples IV(c).

FIG. 3 shows the XRD patterns of the nanocrystals prepared according to Examples III and Examples IV(a)-(c).

FIG. 4 shows the TEM images of the nanocrystals prepared according to Example IV(c).

FIG. 5A shows the HAADF images of the nanocrystals prepared according to Example IV(c).

FIG. 5B shows EDS images of the Cu+Ni in nanocrystals prepared according to Example IV(c).

FIG. 5C shows EDS images of the Cu+Ni+P in nanocrystals prepared according to Example IV(c).

FIG. 5D shows EDS images of the Cu in nanocrystals prepared according to Example IV(c).

FIG. 5E shows EDS images of the Ni in nanocrystals prepared according to Example IV(c).

FIG. 5F shows EDS images of the P in nanocrystals prepared according to Example IV(c).

FIG. 6 shows the energy dispersive X-ray spectrum for the nanocrystals prepared according to Example IV(c).

FIG. 7A shows double-layer capacitance measurements for determining the electrochemically active surface area for electrodeposited nanocrystals according to Example IV(c) from voltammetry in 0.1 M KOH.

FIG. 7B shows the cathodic (gray open circle) and anodic (dark open square) charging currents measured at −0.05 V vs SCE plotted as a function of scan rate.

FIG. 8A shows the polarization curves of the nanocrystals according to Example IV(c) with different loading mass in 0.1M KOH solution.

FIG. 8B shows the calculated overpotential of nanocrystals according to Example IV(c) at I=0.44 V vs RHE (reversible hydrogen electrode).

### DETAILED DESCRIPTION

The present disclosure is directed to nanocatalysts having at least one non-metal component. The nanocatalysts of the present disclosure may be useful for catalyzing the hydrogen evolution reaction. The present disclosure is also directed to methods of making and using the nanocatalysts as described herein.

According to some aspects, the nanocatalyst of the present disclosure may include a nanocrystal. As used herein, the term “crystal” refers to a structure having atoms in either a single- or poly-crystalline arrangement. A “nanocrystal” refers to a crystal having at least one dimension on the nanoscale based on quantum dots, that is, at least one dimension between about 0.1 and 100 nm. At least a portion of the nanocrystals of the present disclosure may have a polyhedral shape with a certain number of faces. For example, the number of faces may be about 4 faces or more, optionally from about 4 faces to about 50 faces, optionally from about 8 faces to about 40 faces, optionally from about 12 faces to about 30 faces, optionally from about 18 faces to about 20 faces. The number of faces may be in multiples of 2 starting with about 4 faces, and/or in multiples of 5 starting with about 5 faces. The number of faces may be one or more of 4, 8, 12, 15, 18, 20 24, 30, 40, or 50 faces.

The nanocatalysts according to the present disclosure may have an average diameter of between 1 and 1000 nm, optionally between about 1 and 500 nm, optionally between about 50 and 200 nm, and optionally between about 100 and 150 nm. In some non-limiting examples, the nanocatalysts according to the present disclosure may have an average diameter of about 1 nm, optionally about 10 nm, optionally about 20 nm, optionally about 30 nm, optionally about 40 nm, optionally about 50 nm, optionally about 60 nm, optionally about 70 nm, optionally about 80 nm, optionally about 90 nm, optionally about 100 nm, optionally about 110 nm, optionally about 120 nm, optionally about 130 nm, optionally about 140 nm, optionally about 150 nm, optionally about 160 nm, optionally about 170 nm, optionally about 180 nm, optionally about 190 nm, and optionally about 200 nm.

According to some aspects, the nanocatalysts of the present disclosure may include at least one non-metal component. In some non-limiting examples, the non-metal component may include one or more of phosphorus, nitrogen, sulfur, and oxygen.

According to some aspects, the nanocatalysts of the present disclosure may further include at least one metal component. In some non-limiting examples, the nanocatalysts may include one, two, three, four, or more metal components, wherein each metal component is a distinct metal. Non-limiting examples of metal components useful according to the present disclosure include any group IB to group VIIIB metal, such as copper, silver, gold, iron, and nickel.

According to some aspects, each metal component may individually be present in the nanocatalyst at an atomic ratio of between about 0.1 and 0.99, including any value therebetween. In some non-limiting examples, the nanocatalyst may have a first metal component and a second metal component provided at an atomic ratio of between about 0.1:1 and 9.9:1, optionally about 1:1.

According to some aspects, the non-metal component may be present in the nanocatalyst at an atomic ratio of between about 0.1 and 0.9, including any value therebetween.

According to some aspects, the nanocatalyst is hollow. As used herein, the term “hollow” refers to a nanostructure having an unfilled space within a continuous outer surface.

The present disclosure is also directed to methods of making the nanocatalysts as described herein. According to some aspects, the method may include providing a metal nanostructure, combining the metal nanostructure with a non-metal source to provide a combination, and heating the combination to provide the nanocatalyst.

The method includes providing a metal nanostructure. As used herein, a “nanostructure” refers to a structure having at least one dimension on the nanoscale as described herein. In some non-limiting examples, the metal nanostructure includes a metal nanocrystal having at least one metal component as described herein, optionally at least two metal components, optionally at least three metal components, and optionally at least four metal components.

According to some aspects, providing a metal nanostructure may include one or more steps as described in U.S. Patent Publication No. 2022/0331788, the contents of which are expressly incorporated by reference herein in their entirety. For example, providing a metal nanostructure may include combining a first metal complex with a second metal complex, wherein each of the first metal complex and the second metal complex independently includes a metal and a nitrogen-containing compound. Non-limiting examples of metals include those described herein, such as any group IB to group VIIIB metal. Non-limiting examples of nitrogen-containing compounds include oleylamine (OLA), octadecylamine (ODA), hexadecylamine (HDA), dodecylamine (DDA), tetradecylamine (TDA), isomers thereof, derivatives thereof, or combinations thereof.

In one non-limiting example, the method may include providing a first metal complex solution and/or a second metal complex solution. According to some aspects, providing the metal complex solution(s) may include mixing a metal source with a nitrogen containing compound as disclosed herein. Example metal sources include metal chlorides, metal nitrates, metal acetylacetonate, metal salts, and combinations thereof.

According to some aspects, the metal source and the nitrogen containing compound may be mixed at an elevated temperature. In some non-limiting examples, the elevated temperature may be between about 100 and 300° C., optionally between about 150 and 250° C., and optionally about 100° C. According to some aspects, the metal source and the nitrogen containing compound may be mixed at the elevated temperature for a time period sufficient to provide a solution containing a metal complex as described herein (alternatively referred to as a “metal complex solution”). In some non-limiting examples, the time period may be between 1 and 30 minutes, optionally between about 1 and 20 minutes, optionally between about 1 and 15 minutes, optionally between about 1 and 10 minutes, optionally about 10 minutes, optionally about 9 minutes, optionally about 8 minutes, optionally about 7 minutes, optionally about 6 minutes, and optionally about 5 minutes.

Non-limiting examples of metal complexes as described herein include Cu-TDA, Cu-OLA, Cu-HDA, Cu-ODA, Ni-TDA, Ni-OLA, Ni-HDA, and Ni-ODA. It should be understood, however, that the metal complex may include any metal useful according to the present disclosure (for example, any group IB to group VIIIB metal) complexed with any nitrogen-containing compound as described herein.

According to some aspects, providing a metal nanostructure as described herein may include combining a first metal complex, a second metal complex, and a nitrogen-phosphorus solution as described in U.S. Patent Publication No. 2022/0331788.

According to some aspects, the nitrogen-phosphorus solution may be provided by combining a phosphorous-containing compound with a deoxygenated nitrogen-containing compound. As used herein, the terms “deoxygenate” refers to removing at least a majority of the oxygen from a solution as known in the art. In some non-limiting examples, deoxygenating a solution may include blowing the solution with a gas such as nitrogen gas, argon gas, helium gas, or a combination thereof.

Non-limiting examples of phosphorous-containing compounds include alkylphosphines and/or arylphosphines such as trimethylphosphine, tricthylphosphine, tripropylphosphine, tributylphosphine, tripentylphosphine, trihexylphosphine, trioctylphosphine, tricyclohexylphosphine, di ethylphosphine, dibutylphosphine, diphenylphosphine, dimethylethylphosphine, triphenylphosphine, isomers thereof, derivatives thereof, and combinations thereof.

The method may include heating the nitrogen-phosphorus solution to a first elevated temperature, combining a first metal complex as described herein with the heated nitrogen-phosphorus solution to provide a first combined solution, cooling the first combined solution to a second elevated temperature, and combining the first combined solution with a second metal complex as described herein to provide a reaction product containing metal nanostructure as described herein.

According to some aspects, the first elevated temperature may be between about 200 and 400° C., optionally between about 250 and 350° C., and optionally about 300° C. According to some aspects, the second elevated temperature may be between about 80 and 300° C., optionally between about 100 and 200° C., optionally between about 100 and 150° C., and optionally about 120° C.

According to some aspects, the reaction product containing the metal nanostructures may further be subjected to one or more of filtration, separation, cleaning, quenching, washing, purification, and/or other processes to remove undesired components and/or isolate the metal nanostructures from the other components of the reaction product. For example, a reaction product solution containing the metal nanostructures may be centrifuged to separate the metal nanostructures (which may be in the form of particles) from the rest of the reaction product. Additionally, or alternatively, the metal nanostructures may be washed with polar solvent(s), such as water, acetone, ethanol, methanol, or combinations thereof, and/or non-polar solvent(s), such as hexane, pentane, toluene, or combinations thereof. Other solvents for washing may include ether solvents such as diethyl ether and tetrahydrofuran, chlorocarbon solvents such as dichloromethane and chloroform, ethyl acetate, dimethylformamide, acetonitrile, benzene, isopropanol, and n-butanol, n-propanol. Mixtures of two or more of these solvents, in suitable proportions, may be utilized for washing, purifying, or otherwise separating the metal nanostructures from other components in the reaction product. As an example, a solvent or mixture of solvents may be added to the metal nanostructures (or a solution containing the same) and the resultant mixture may be centrifuged. The supernatant may be discarded and the remaining pellet may be dispersed in a suitable solvent or mixture of solvents as described herein. The resultant pellet and solvent(s) may then be centrifuged to obtain the metal nanostructures.

The method further includes combining the metal nanostructures with a non-metal source. As used herein, a “non-metal source” refers to one or more compounds having the non-metal component as described herein. In some non-limiting examples, the non-metal source may include an alkyl phosphine, alkyl mercaptan, oxygen, nitrogen, or a combination thereof. Non-limiting examples of alkyl phosphines include trialkylphosphines, tributylphosphines, triethylphosphines, trihexylphosphines, and combinations thereof. Non-limiting examples of nitrogen source include ammonia, hydrazine, ammonia hydroxide, and combinations thereof. Non-limiting examples of sulfur source include sulfur powder, hydrazine, alkyl mercaptans, hydrogen sulfide, and combinations thereof. Non-limiting examples of oxygen source include pure oxygen, atmospheric air, hydrogen peroxide, and combinations thereof.

The method may include one or more of combining the metal nanostructures with the non-metal source to provide a combination, deoxygenating the combination, and heating the combination to an elevated temperature to provide a reaction product containing the nanocatalysts as described herein. It should be understood that the combining, deoxygenating, and/or heating may be performed in discrete steps such that the metal nanostructures and the non-metal source are combined and subsequently deoxygenated and/or heated to the elevated temperature. However, the disclosure is not limited in this way. For example, one or both of the metal nanostructures and the non-metal source may be independently deoxygenated and/or heated prior to and/or during combination such that the combination is provided at the elevated temperature as described herein.

According to the some aspects, the elevated temperature is sufficient to provide a hollow nanostructure as described herein. Without wishing to be bound by theory, the hollow nanostructure may be provided by the Kirkendall effect, wherein metal atoms interior to the metal nanostructures diffuse to the exterior of the nanostructures. As used herein, the term “exterior” refers to a position at and/or near the surface of the nanostructure. The term “interior” refers to a position away from the surface of the nanostructure.

According to some aspects, the elevated temperature may be between about 150 and 400° C., optionally between about 200 and 350° C., optionally between about 250 and 350° C. optionally about 200° C., optionally about 250° C., and optionally about 300° C. According to some aspects, the elevated temperature may be at least about 200° C., optionally at least about 250° C. and optionally at least about 300° C.

According to some aspects, the combination may be held at the elevated temperature for a time period sufficient for non-metal atoms to replace a corresponding number of metal atoms and/or to promote metal atom diffusion as described herein. According to some aspects, the combination may be held at the elevated temperature for a time period of between about 1 minute to 20 hours, optionally between about 5 minutes and 10 hours, optionally between about 1 and 5 hours, optionally between about 2 and 4 hours, and optionally about 3 hours.

According to some aspects, the reaction product containing the nanocatalysts may be cooled to room temperature and optionally subjected to one or more further processing steps. As used herein, room temperature is between about 20 and 25° C., optionally between about 20 and 22° C. According to some aspects, the further processing steps may include one or more of filtration, separation, cleaning, quenching, washing, purification, and/or other processes to remove undesired components and/or isolate the nanocatalyst from other components of the reaction product, as described herein. For example, a reaction product solution containing the nanocatalysts may be centrifuged to separate the nanocatalysts from the rest of the reaction product. Additionally, or alternatively, the nanocatalysts may be washed with a solvent as described herein. As an example, a solvent or mixture of solvents may be added to the nanocatalysts (or a solution containing the same) and the resultant mixture may be centrifuged. The supernatant may be discarded and the remaining pellet may be dispersed in a suitable solvent or mixture of solvents as described herein. The resultant pellet and solvent(s) may then be centrifuged to obtain the metal nanostructures.

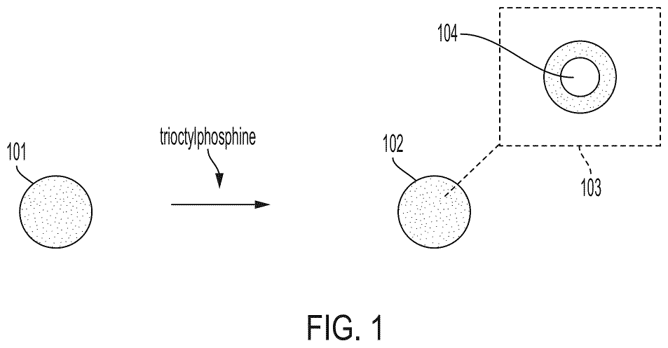

FIG. 1 shows one example schematic of a method according to the present disclosure. In particular, FIG. 1 shows a metal nanostructure 101 combined with trioctylphosphine to provide a nanocatalyst 102 as described herein. FIG. 1 further shows a cutaway view 103 of nanocatalyst 102 in order to demonstrate its hollow center 104.

According to some aspects, all or a portion of the method may be a one-pot method. As used herein, the term “one-pot method” refers to a method wherein one or more reactants are subjected to one or more successive chemical reactions in a single reactor, that is, without requiring intermittent purification steps. For example, providing a nanocatalyst from a metal nanostructure as described herein may be a one-pot method.

The present disclosure is also directed to methods of using the nanocatalysts as described herein. For example, the method may include incorporating the nanocatalysts in a proton exchange membrane fuel cell. Additionally or alternatively, the method may include using the nanocatalysts to catalyze the hydrogen evolution reaction and carbon dioxide reduction. As used here, the hydrogen evolution reaction refers to a chemical reaction that yields H₂, and carbon dioxide reduction refers to a chemical reaction that transfers carbon dioxides to valuable chemicals, including but not limited to ethanol, methanol, glucose, and combinations thereof. In some non-limiting examples, the method may include contacting a source of protons with the nanocatalyst described herein to produce H₂. The present disclosure is further directed to proton exchange membrane fuel cells containing the nanocatalysts as described herein, wherein the proton exchange membrane fuel cell may include one or more electrodes and electrolytes as known in the art.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Herein, the recitation of numerical ranges by endpoints (e.g. between about 50:1 and 1:1, between about 100 and 500° C., between about 1 minute and 60 minutes) include all numbers subsumed within that range, for example, between about 1 minute and 60 minutes includes 21, 22, 23, and 24 minutes as endpoints within the specified range. Thus, for example, ranges 22-36, 25-32, 23-29, etc. are also ranges with endpoints subsumed within the range 1-60 depending on the starting materials used, temperature, specific applications, specific embodiments, or limitations of the claims if needed. The Examples and methods disclosed herein demonstrate the recited ranges subsume every point within the ranges because different synthetic products result from changing one or more reaction parameters. Further, the methods and Examples disclosed herein describe various aspects of the disclosed ranges and the effects if the ranges are changed individually or in combination with other recited ranges.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

As used herein, the term “about” and “approximately” are defined to being close to as understood by one of ordinary skill in the art. In one non-limiting embodiment, the term “about” and “approximately” are defined to be within 10%, preferably within 5%, more preferably within 1%, and most preferably within 0.5%.

The examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

### EXAMPLES

### Example I: Synthesis of Cu-TDA Precursor Stock Solution

First, 100 mg of copper (I) chloride (1.0 mmol), 240 mg of TDA, and 2 mL of ODE were added to a flask under Ar or N₂ flow. After Ar or N₂ blowing for 20 minutes, the mixed solutions were heated to 200° C. and kept at this temperature for 10 minutes.

### Example II: Synthesis of Ni-OLA Precursor Stock Solution

128 mg of nickel acetylacetonate (0.5 mmol) and 4.0 mL OLA were heated and shaken for 5 minutes.

### Example III: Synthesis of Copper-Nickel Polyhedral Nanocrystals

First, 6.0 mL of OLA (70%) was loaded in a 50 mL three-neck flask where oxygen was removed through Ar blowing for 20 minutes. Then, 1.0 mL of TOP was injected into the flask under Ar flow. After 20 minutes of Ar flowing, the flask was rapidly heated to 300° C. Next, 2 mL of a Cu-TDA stock solution prepared according to Example 1 was quickly injected into a hot flask, and the reaction solution turned to red. Then, the reaction solution was cooled to 120° C. and a Ni-OLA stock solution prepared according to Example II was injected and kept at this temperature. After reacting for 1 hour, the reaction solution was heated to 250° C. and kept at this temperature for 5 minutes. Then reaction solution was cooled to room temperature and 5 mL of hexane and 5 mL of ethanol were injected. The products were separated by centrifuging at 4000 rpm for 5 minutes. The supernatant was discarded. 10 mL of hexane was then added to the sediment, and the mixture was centrifuged at 4000 rpm for 5 minutes. The washing procedure was repeated twice to remove unreacted precursors and surfactant. The copper-nickel polyhedral nanocrystals were stored in hydrophobic solvents before characterization.

### Example IV(a): Synthesis of Copper-Nickel Phosphide Nanocrystals

First, 20 mg of Cu—Ni polyhedral nanocrystals prepared according to Example III were dispersed in 6.0 mL of trioctylphosphine and loaded in a 50 mL three-neck flask where oxygen was removed through Ar blowing for 20 minutes. After 20 minutes of Ar blowing, the flask was rapidly heated to 200° C. and kept at this temperature for 3 hours. The reaction solution was then cooled to room temperature, and 5 mL of hexane and 5 mL of ethanol were injected. The products were separated by centrifuging at 4000 rpm for 5 minutes. The supernatant was discarded. 10 mL of hexane was then added to the sediment, and the mixture was centrifuged at 4000 rpm for 5 minutes. The washing procedure was repeated twice to remove unreacted precursors and surfactant. The copper-nickel polyhedral nanocrystals were stored in hydrophobic solvents before characterization.

### Example IV(b): Synthesis of Copper-Nickel Phosphide Nanocrystals

First, 20 mg of Cu—Ni polyhedral nanocrystals prepared according to Example III were dispersed in 6.0 mL of trioctylphosphine and loaded in a 50 mL three-neck flask where oxygen was removed through Ar blowing for 20 minutes. After 20 minutes of Ar blowing, the flask was rapidly heated to 250° C. and kept at this temperature for 3 hours. The reaction solution was then cooled to room temperature, and 5 mL of hexane and 5 mL of ethanol were injected. The products were separated by centrifuging at 4000 rpm for 5 minutes. The supernatant was discarded. 10 mL of hexane was then added to the sediment, and the mixture was centrifuged at 4000 rpm for 5 minutes. The washing procedure was repeated twice to remove unreacted precursors and surfactant. The copper-nickel polyhedral nanocrystals were stored in hydrophobic solvents before characterization.

### Example IV(c): Synthesis of Copper-Nickel Phosphide Nanocrystals

First, 20 mg of Cu—Ni polyhedral nanocrystals prepared according to Example III were dispersed in 6.0 mL of trioctylphosphine and loaded in a 50 mL three-neck flask where oxygen was removed through Ar blowing for 20 minutes. After 20 minutes of Ar blowing, the flask was rapidly heated to 300° C. and kept at this temperature for 3 hours. The reaction solution was then cooled to room temperature, and 5 mL of hexane and 5 mL of ethanol were injected. The products were separated by centrifuging at 4000 rpm for 5 minutes. The supernatant was discarded. 10 mL of hexane was then added to the sediment, and the mixture was centrifuged at 4000 rpm for 5 minutes. The washing procedure was repeated twice to remove unreacted precursors and surfactant. The copper-nickel polyhedral nanocrystals were stored in hydrophobic solvents before characterization.

### Example V: Characterization of Copper-Nickel Phosphide Nanocrystals

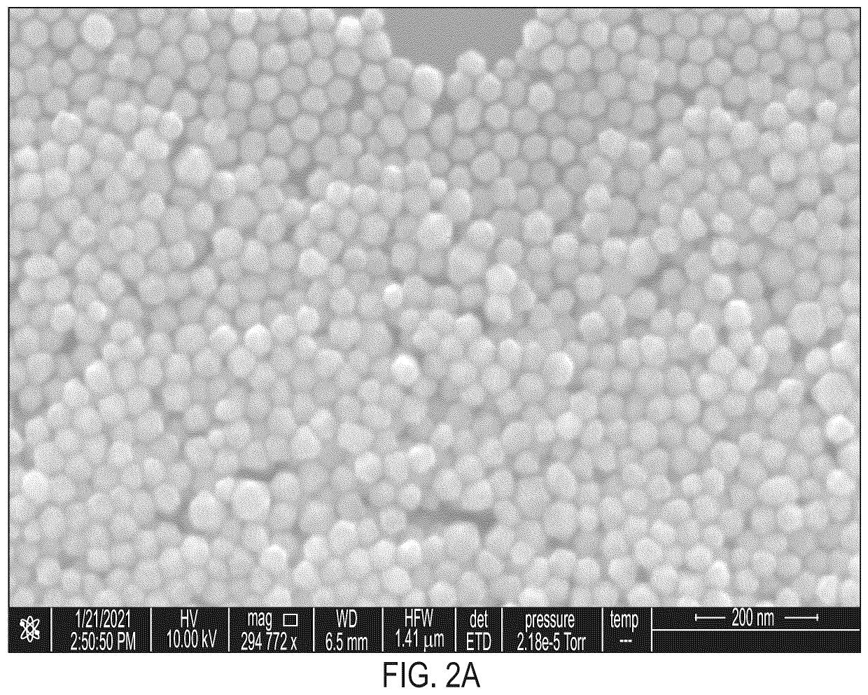

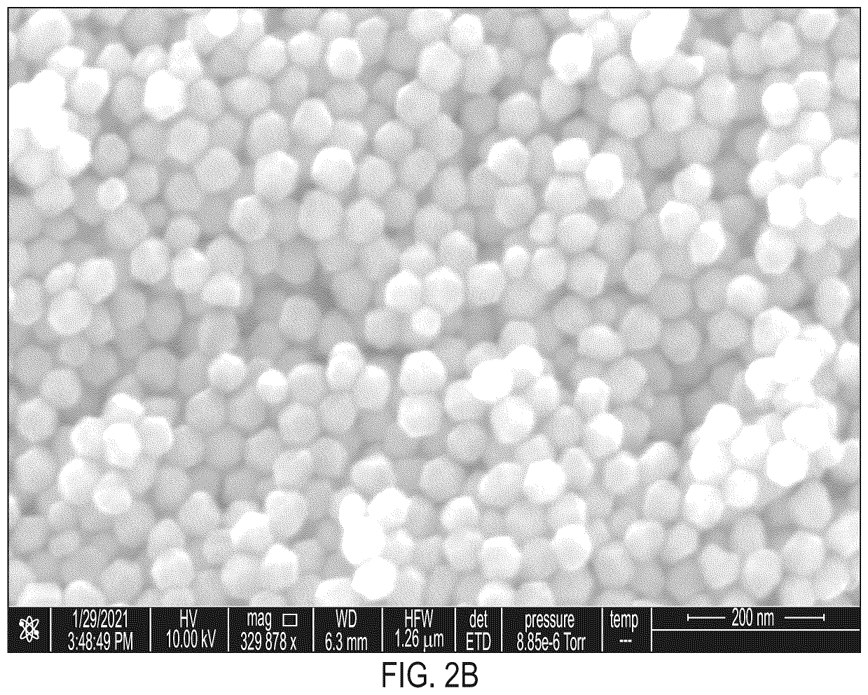

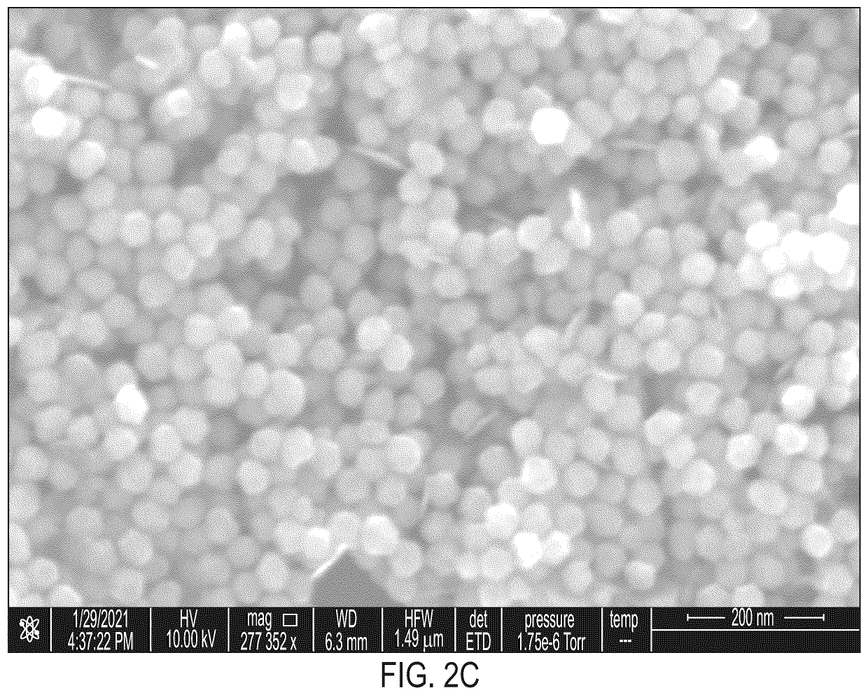

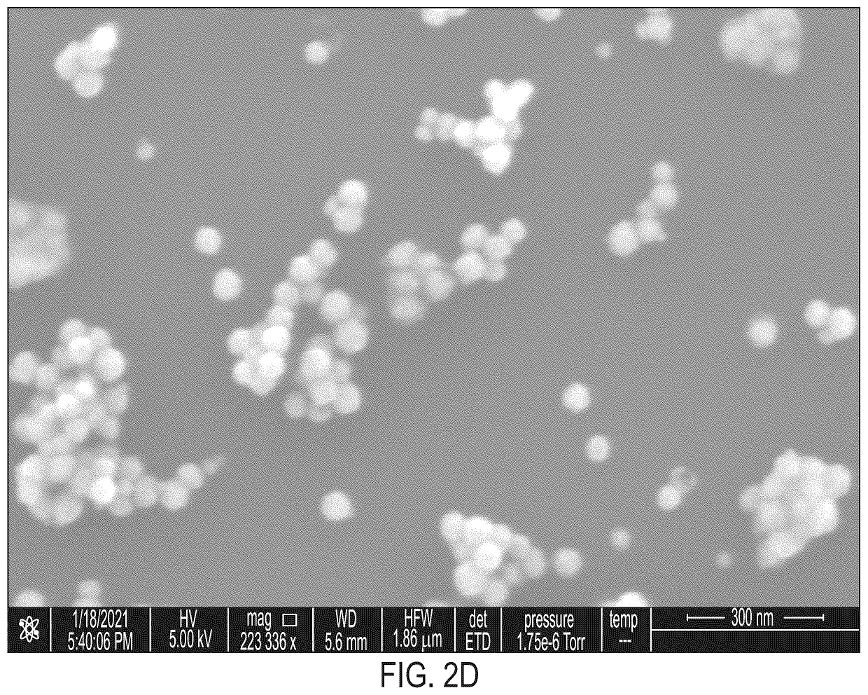

The surface morphologies of the copper-nickel polyhedral nanoparticles prepared according to Example III and the copper-nickel phosphide nanocrystals prepared according to Examples IV(a)-(c) were investigated by a scanning electron microscope (SEM, QUANTA FEG 650) from FEI with a field emitter as electron source. FIG. 2A shows an SEM image of the copper-nickel polyhedral nanoparticles prepared according to Example III. FIG. 2B shows an SEM image of the copper-nickel phosphide nanocrystals prepared according to Examples IV(a). FIG. 2C shows an SEM image of the copper-nickel phosphide nanocrystals prepared according to Examples IV(b). FIG. 2D shows an SEM image of the copper-nickel phosphide nanocrystals prepared according to Examples IV(c).

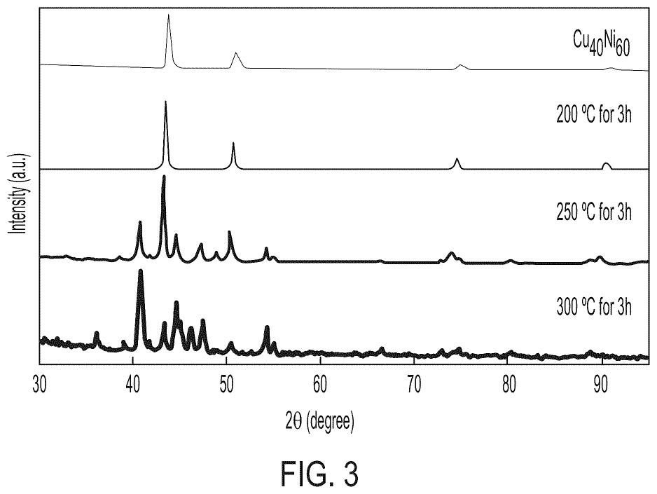

A Bruker D8 Advance X-ray diffractometer with Cu Kα radiation operated at a tube voltage of 40 kV and a current of 40 mA was then used to obtain X-ray diffraction (XRD) patterns. FIG. 3 shows the XRD patterns of the nanocrystals prepared according to Examples III and Examples IV(a)-(c). Based on FIG. 3, it was concluded that the nanocrystals prepared according to Examples III had {111}, {200}, {220} diffraction peaks, which was consist with a face centered cubic nanostructure. The additional peaks appearing for Examples IV(a)-(c) were due to the formation of a metal phosphide.

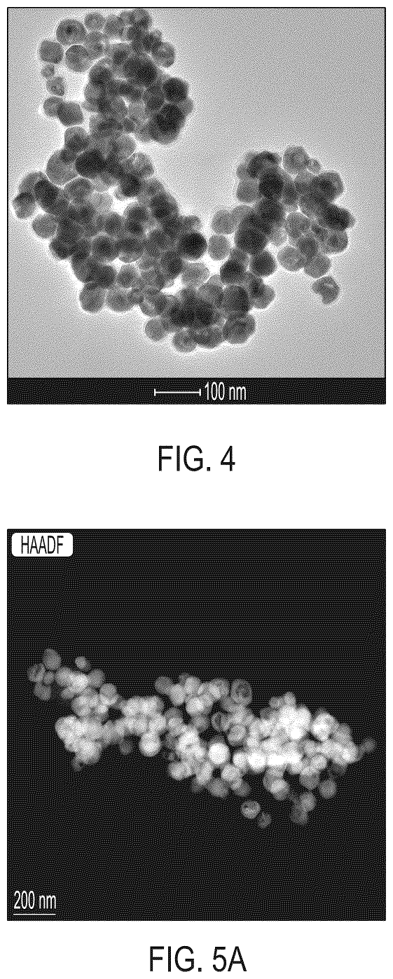

Transmission electron microscopy (TEM) images were captured using an FEI Tecnai 20 microscope with an accelerating voltage of 200 kV. FIG. 4 shows the TEM images of the nanocrystals prepared according to Example IV(c).

Energy Dispersive X-Ray spectrometer (EDS) mapping image and the high-angle annular dark-field (HAADF) image were collected by employing the probe-corrected Titan^{3™} 80-300 S/TEM with an accelerating voltage of 300 kV.

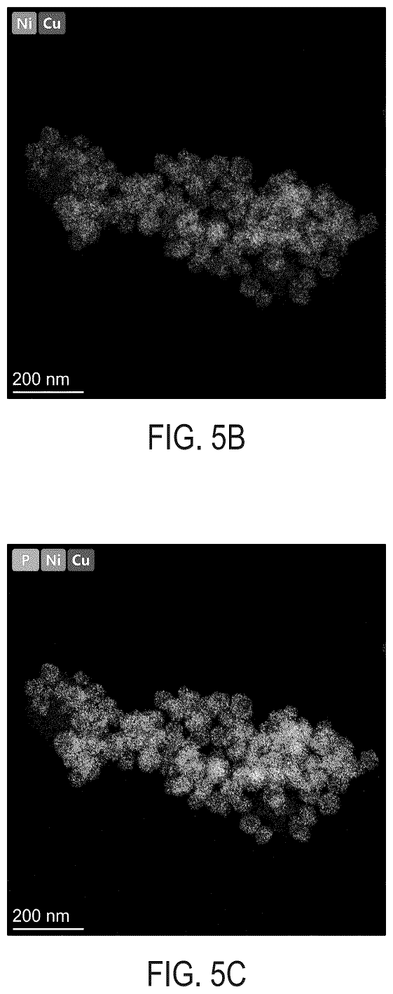

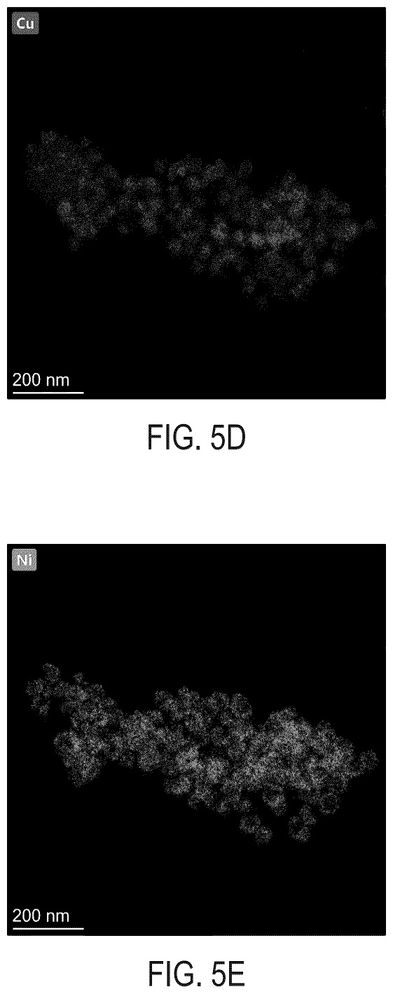

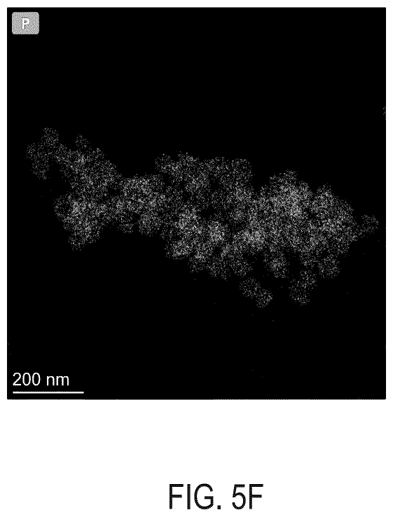

FIG. 5A shows the HAADF images of the nanocrystals prepared according to Example IV(c). FIGS. 5B-5F show the EDS images of the nanocrystals prepared according to Example IV(c). Specifically, FIG. 5B shows EDS images of the Cu+Ni in nanocrystals prepared according to Example IV(c). FIG. 5C shows EDS images of the Cu+Ni+P in nanocrystals prepared according to Example IV(c). FIG. 5D shows EDS images of the Cu in nanocrystals prepared according to Example IV(c). FIG. 5E shows EDS images of the Ni in nanocrystals prepared according to Example IV(c). FIG. 5F shows EDS images of the P in nanocrystals prepared according to Example IV(c).

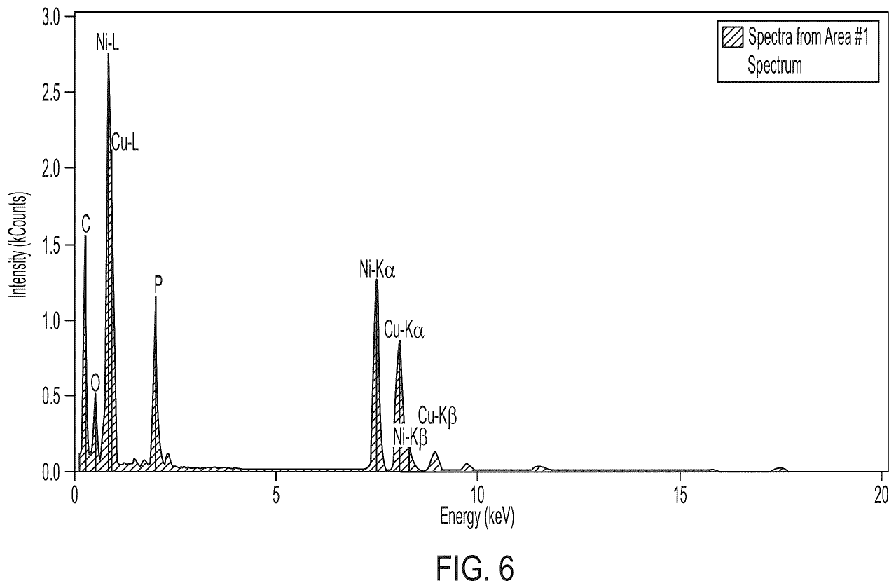

FIG. 6 shows the energy dispersive X-ray spectrum for the nanocrystals prepared according to Example IV(c).

Based on the above, it was determined that copper-nickel phosphide nanocatalysts have been synthesized via the ripening of copper-nickel nanocrystals at above 200° C. Specifically, trioctylphosphine acts as a phosphorus source to react with copper-nickel nanocrystals. XRD patterns indicate ripening temperature is very important for the formation of the metal phosphide.

### Example VI: Catalytic Effectiveness of Copper-Nickel Phosphide Nanocrystals

Nanocrystals prepared according to Example IV(c) were provided in solution, sonicated well, and placed onto the RDE, there the rotating speed was 700 rpm until dry. Then, a 0.1 M KOH solution was purged by pure N₂ for 1 hour to remove the excessive dissolved air or oxygen. The electrochemical catalytic properties of the nanocrystals were then measured using a three-electrode system, i.e., a working electrode, glassy carbon RED with an area 0.196 cm²; counter electrode, graphite rode; and reference electrode, Ag/AgCl sat. KCl. The nanocrystals were activated in KOH solution by scanning 20 cycles CV at 100 mV/s, and then recorded a CV at 50 mV/s. The ECSA was estimated by double layer capacitance, i=C_{dl}×v The HER activity was measured by LSV at 5 mV/s, from 0 V to 0.9 V vs RHE. The RDE was kept rotating at 1600 rpm during the process to avoid generated H2 bulbs. The solution was maintained to be saturated by N₂.

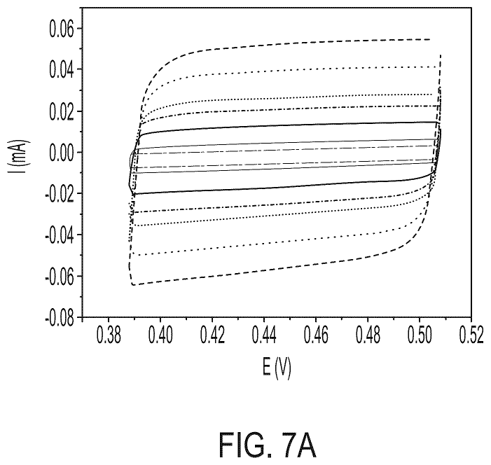

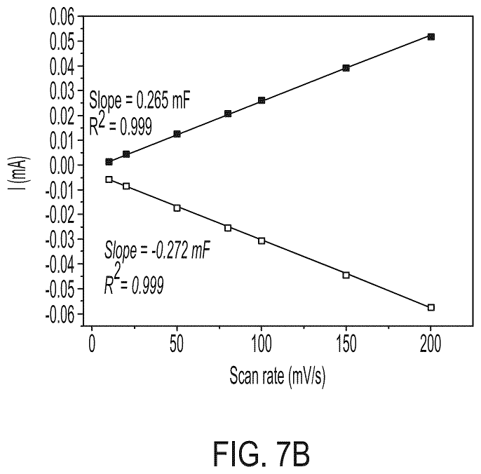

FIG. 7A shows double-layer capacitance measurements for determining the electrochemically active surface area for electrodeposited nanocrystals according to Example IV(c) from voltammetry in 0.1 M KOH. Cyclic voltammograms were measured in a non-Faradaic region of the voltammogram at the following scan rate: (dark line) 0.01, (light gray line) 0.02, (gray line) 0.05, (dark dot line) 0.08, (light gray dot line) 0.1, (gray dot line) 0.15, (gray dash) 0.2 V/s. The working electrode was held at each potential vertex for 10 seconds before the beginning the next sweep. All current is assumed to be due to capacitive charging. FIG. 7B shows the cathodic (gray open circle) and anodic (dark open square) charging currents measured at −0.05 V vs SCE plotted as a function of scan rate. The determined double-layer capacitance of the system is taken as the average of the absolute value of the slope of the linear fits to the data.

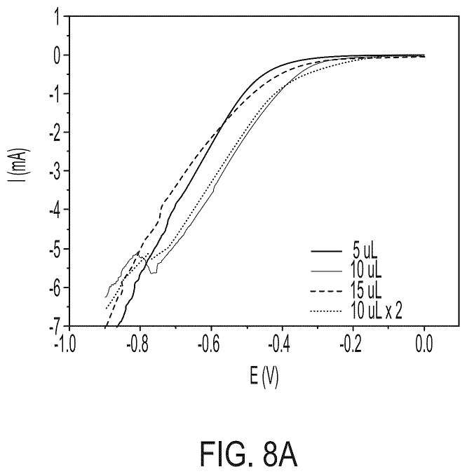

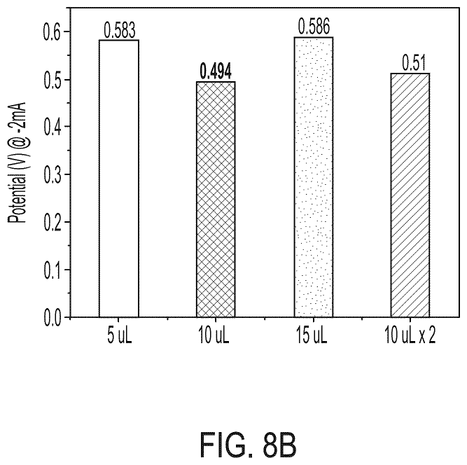

FIG. 8A shows the polarization curves of the nanocrystals according to Example IV(c) with different loading mass in 0.1M KOH solution. FIG. 8B shows the calculated overpotential of nanocrystals according to Example IV(c) at I=0.44 V vs RHE (reversible hydrogen electrode). The lowest overpotential of the nanocrystals are 0.494 Voltage.

Based on the above, it was determined that copper-nickel phosphide nanocatalysts can act as catalysts to generate hydrogen at lower overpotential of 0.494 voltage.

What is claimed is:

1. A method of making a hollow nanocatalyst having at least one non-metal component, comprising:
providing a metal nanostructure;
combining the metal nanostructure with a non-metal source to provide a combination; and
heating the combination to a first elevated temperature to provide the hollow nanocatalyst.

2. The method of claim 1, wherein the metal nanostructure comprises a metal nanocrystal.

3. The method of claim 1, wherein the metal nanostructure comprises copper, nickel, or a combination thereof.

4. The method according to claim 1, wherein the non-metal source comprises phosphorus.

5. The method according to claim 1, wherein the non-metal source comprises nitrogen.

6. The method according to claim 1, wherein the non-metal source comprises sulfur.

7. The method according to claim 1, wherein the non-metal source comprises oxygen.

8. The method according to claim 1, wherein the non-metal source comprises an alkyl phosphine.

9. The method according to claim 1, wherein the elevated temperature is between about 150 and 400° C.

10. A nanocatalyst comprising:
a first metal component, a second metal component, and a non-metal component,
wherein the nanocatalyst is hollow.

11. The nanocatalyst according to claim 10, wherein the nanocatalyst is a nanocrystal.

12. The nanocatalyst according to claim 10, wherein the first metal component comprises copper.

13. The nanocatalyst according to claim 10, wherein the second metal component comprises nickel.

14. The nanocatalyst according to claim 10, wherein the non-metal component comprises phosphorus.

15. The nanocatalyst according to claim 10, wherein the non-metal component comprises nitrogen.

16. The nanocatalyst according to claim 10, wherein the non-metal component comprises sulfur.

17. The nanocatalyst according to claim 10, wherein the non-metal component comprises oxygen.

18. The nanocatalyst according to claim 10, wherein the non-metal component is present in the nanocatalyst at an atomic ratio of between about 0.1 and 0.9.

19. A proton exchange membrane fuel cell comprising:
the nanocatalyst according to claim 10; and
at least one electrode.

20. A method comprising contacting a source of protons with the nanocatalyst according to claim 10 to produce H₂.
